(19) United States
(12) Patent Application Publication
(10) Pub. No.: US 2023/0106154 A1
(43) Pub. Date: Apr. 6, 2023

(54) SYSTEM AND METHOD FOR CUSTOMIZED WEBSITE CONTENT AUTOMATION

(71) Applicant: Matthew Khorsandi, West Hollywood, CA (US)

(72) Inventor: Matthew Khorsandi, West Hollywood, CA (US)

(21) Appl. No.: 17/549,375

(22) Filed: Dec. 13, 2021

Related U.S. Application Data
(60) Provisional application No. 63/251,897, filed on Oct. 4, 2021.

(51) Int. Cl. G06F 16/958; G06F 16/909; G06F 16/908; G06F 16/955

(52) U.S. Cl. CPC G06F 16/958; G06F 16/909; G06F 16/908; G06F 16/955

(57) ABSTRACT

A method of serving geo-specific web landing pages comprises: receiving, at a first device, code of a seed landing page; inserting, by the first device, a geo-specific variable into the seed landing page code; receiving, at the first device, content to replace the geo-specific variable as a function of geography; generating, by the first device, a plurality of geo-specific landing pages based on the geo-specific variables and the generated content; receiving, from a client device, a request for a geo-specific landing page of the generated plurality of geo-specific landing pages; and serving, to the client device, the requested geo-specific landing page.

### CROSS-REFERENCE TO RELATED APPLICATIONS

This application claims priority to and incorporates by reference U.S. Provisional Patent Application No. 63/251,897 filed Oct. 4, 2021.

### BACKGROUND

Geo-targeted landing pages are unique for each location and reduce bandwidth usage by presenting users with landing pages relevant to their location.

### SUMMARY

A method of serving unique (geo-specific) web landing pages comprises: receiving, at a first device, code of a seed landing page; inserting, by the first device, a (geo-specific) variable into the seed landing page code; receiving, at the first device, content to replace the variable as a function of desired content; generating, by the first device, a plurality of unique (geo-specific) landing pages based on the variables and the content; receiving, from a client device, a request for one unique (geo-specific) landing page of the generated plurality of landing pages; and serving, to the client device, the requested (geo-specific) landing page.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some nonlimiting examples are illustrated in the figures of the accompanying drawings in which:

FIG. 1 is a diagrammatic representation of a machine in the form of a computer system within which a set of instructions may be executed for causing the machine to perform any one or more of the methodologies discussed herein, in accordance with some examples.

FIG. 2 is a block diagram showing a software architecture within which examples may be implemented.

FIG. 3 is a diagrammatic representation of a processing environment, in accordance with some examples.

FIG. 4 illustrates a method in accordance with one embodiment.

FIG. 5 illustrates an example seed landing page.

FIG. 6 illustrates a network implementing the method illustrated by FIG. 4.

### DETAILED DESCRIPTION

Machine Architecture

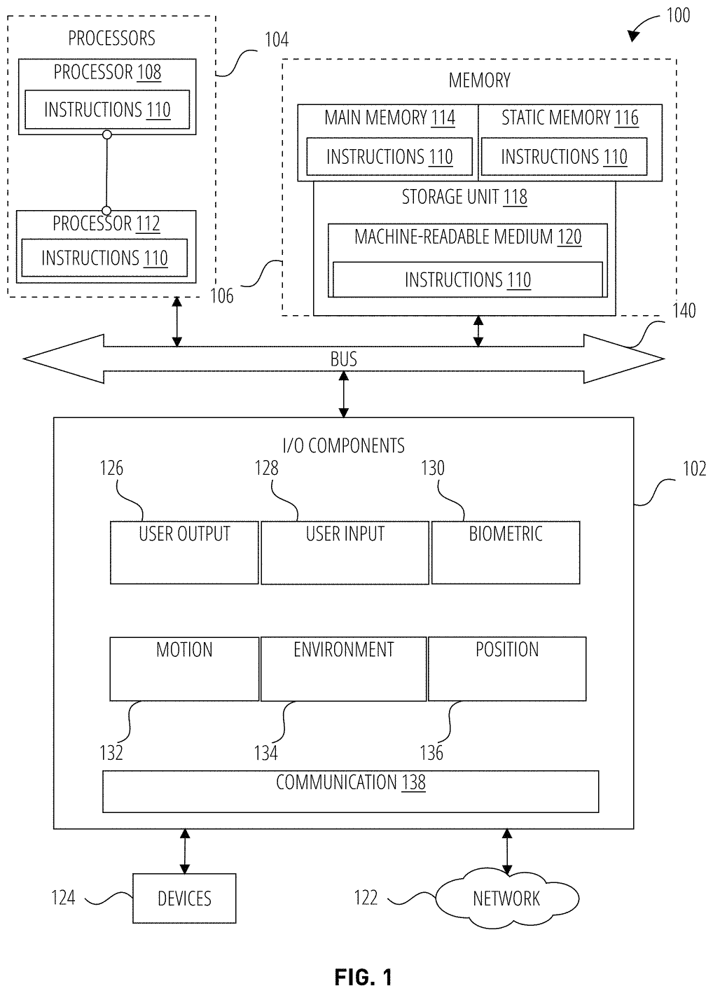

FIG. 1 is a diagrammatic representation of the machine 100 within which instructions 110 (e.g., software, a program, an application, an applet, an app, or other executable code) for causing the machine 100 to perform any one or more of the methodologies discussed herein may be executed. For example, the instructions 110 may cause the machine 100 to execute any one or more of the methods described herein. The instructions 110 transform the general, non-programmed machine 100 into a particular machine 100 programmed to carry out the described and illustrated functions in the manner described. The machine 100 may operate as a standalone device or may be coupled (e.g., networked) to other machines. In a networked deployment, the machine 100 may operate in the capacity of a server machine or a client machine in a server-client network environment, or as a peer machine in a peer-to-peer (or distributed) network environment. The machine 100 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 110, sequentially or otherwise, that specify actions to be taken by the machine 100. Further, while only a single machine 100 is illustrated, the term “machine” shall also be taken to include a collection of machines that individually or jointly execute the instructions 110 to perform any one or more of the methodologies discussed herein. The machine 100, for example, may comprise a client device or any one of a number of server devices forming part of a system. In some examples, the machine 100 may also comprise both client and server systems, with certain operations of a particular method or algorithm being performed on the server-side and with certain operations of the particular method or algorithm being performed on the client-side.

The machine 100 may include processors 104, memory 106, and input/output I/O components 102, which may be configured to communicate with each other via a bus 140. In an example, the processors 104 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 108 and a processor 112 that execute the instructions 110. The term “processor” is intended to include multi-core processors that may comprise two or more independent processors (sometimes referred to as “cores”) that may execute instructions contemporaneously. Although FIG. 1 shows multiple processors 104, the machine 100 may include a single processor with a single-core, a single processor with multiple cores (e.g., a multi-core processor), multiple processors with a single core, multiple processors with multiples cores, or any combination thereof.

The memory 106 includes a main memory 114, a static memory 116, and a storage unit 118, both accessible to the processors 104 via the bus 140. The main memory 106, the static memory 116, and storage unit 118 store the instructions 110 embodying any one or more of the methodologies or functions described herein. The instructions 110 may also reside, completely or partially, within the main memory 114, within the static memory 116, within machine-readable medium 120 within the storage unit 118, within at least one of the processors 104 (e.g., within the Processor's cache memory), or any suitable combination thereof, during execution thereof by the machine 100.

The I/O components 102 may include a wide variety of components to receive input, provide output, produce output, transmit information, exchange information, capture measurements, and so on. The specific I/O components 102 that are included in a particular machine will depend on the type of machine. For example, portable machines such as mobile phones may include a touch input device or other such input mechanisms, while a headless server machine will likely not include such a touch input device. It will be appreciated that the I/O components 102 may include many other components that are not shown in FIG. 1. In various examples, the I/O components 102 may include user output components 126 and user input components 128. The user output components 126 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 128 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 102 may include biometric components 130, motion components 132, environmental components 134, or position components 136, among a wide array of other components. For example, the biometric components 130 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 132 include acceleration sensor components (e.g., accelerometer), gravitation sensor components, rotation sensor components (e.g., gyroscope).

The environmental components 134 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

The position components 136 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 102 further include communication components 138 operable to couple the machine 100 to a network 122 or devices 124 via respective coupling or connections. For example, the communication components 138 may include a network interface Component or another suitable device to interface with the network 122. In further examples, the communication components 138 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 124 may be another machine or any of a wide variety of peripheral devices (e.g., a peripheral device coupled via a USB).

Moreover, the communication components 138 may detect identifiers or include components operable to detect identifiers. For example, the communication components 138 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 138, such as location via Internet Protocol (IP) geolocation, location via Wi-Fi® signal triangulation, location via detecting an NFC beacon signal that may indicate a particular location, and so forth.

The various memories (e.g., main memory 114, static memory 116, and memory of the processors 104) and storage unit 118 may store one or more sets of instructions and data structures (e.g., software) embodying or used by any one or more of the methodologies or functions described herein. These instructions (e.g., the instructions 110), when executed by processors 104, cause various operations to implement the disclosed examples.

The instructions 110 may be transmitted or received over the network 122, using a transmission medium, via a network interface device (e.g., a network interface component included in the communication components 138) and using any one of several well-known transfer protocols (e.g., hypertext transfer protocol (HTTP)). Similarly, the instructions 110 may be transmitted or received using a transmission medium via a coupling (e.g., a peer-to-peer coupling) to the devices 124.

Software Architecture

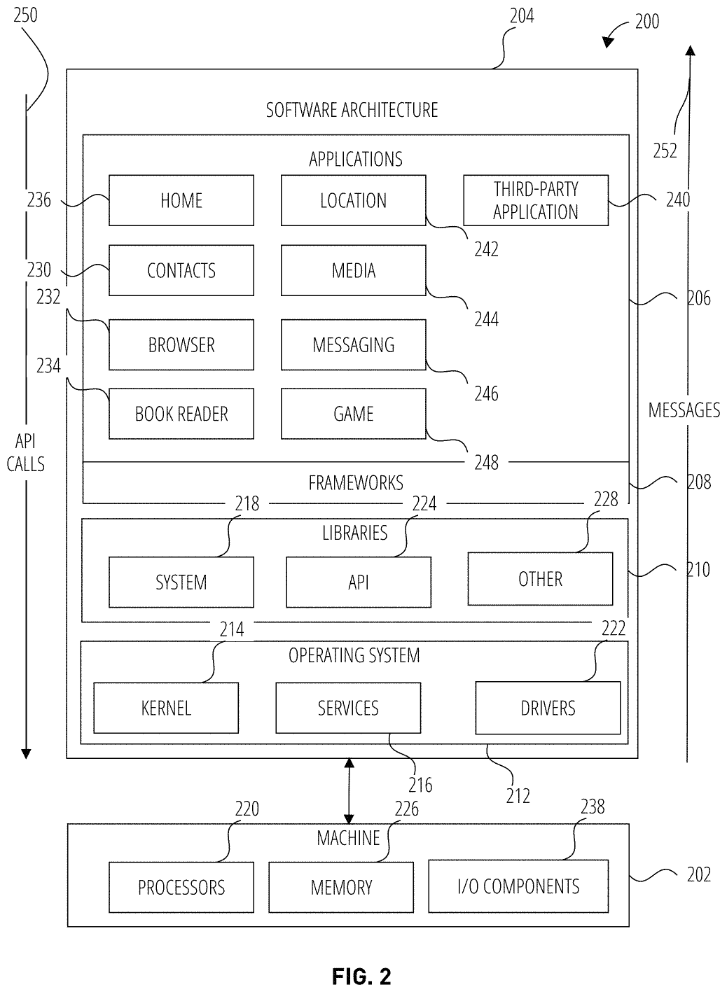

FIG. 2 is a block diagram 200 illustrating a software architecture 204, which can be installed on any one or more of the devices described herein. The software architecture 204 is supported by hardware such as a machine 202 that includes processors 220, memory 226, and I/O components 238. In this example, the software architecture 204 can be conceptualized as a stack of layers, where each layer provides a particular functionality. The software architecture 204 includes layers such as an operating system 212, libraries 210, frameworks 208, and applications 206. Operationally, the applications 206 invoke API calls 250 through the software stack and receive messages 252 in response to the API calls 250.

The operating system 212 manages hardware resources and provides common services. The operating system 212 includes, for example, a kernel 214, services 216, and drivers 222. The kernel 214 acts as an abstraction layer between the hardware and the other software layers. For example, the kernel 214 provides memory management, processor management (e.g., scheduling), component management, networking, and security settings, among other functionality. The services 216 can provide other common services for the other software layers. The drivers 222 are responsible for controlling or interfacing with the underlying hardware. For instance, the drivers 222 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 210 provide a common low-level infrastructure used by the applications 206. The libraries 210 can include system libraries 218 (e.g., C standard library) that provide functions such as memory allocation functions, string manipulation functions, mathematic functions, and the like. In addition, the libraries 210 can include API libraries 224 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 210 can also include a wide variety of other libraries 228 to provide many other APIs to the applications 206.

The frameworks 208 provide a common high-level infrastructure that is used by the applications 206. For example, the frameworks 208 provide various graphical user interface (GUI) functions, high-level resource management, and high-level location services. The frameworks 208 can provide a broad spectrum of other APIs that can be used by the applications 206, some of which may be specific to a particular operating system or platform.

In an example, the applications 206 may include a home application 236, a contacts application 230, a browser application 232, a book reader application 234, a location application 242, a media application 244, a messaging application 246, a game application 248, and a broad assortment of other applications such as a third-party application 240. The applications 206 are programs that execute functions defined in the programs. Various programming languages can be employed to create one or more of the applications 206, structured in a variety of manners, such as object-oriented programming languages (e.g., Objective-C, Java, or C++) or procedural programming languages (e.g., C or assembly language). In a specific example, the third-party application 240 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 240 can invoke the API calls 250 provided by the operating system 212 to facilitate functionality described herein.

Processing Components

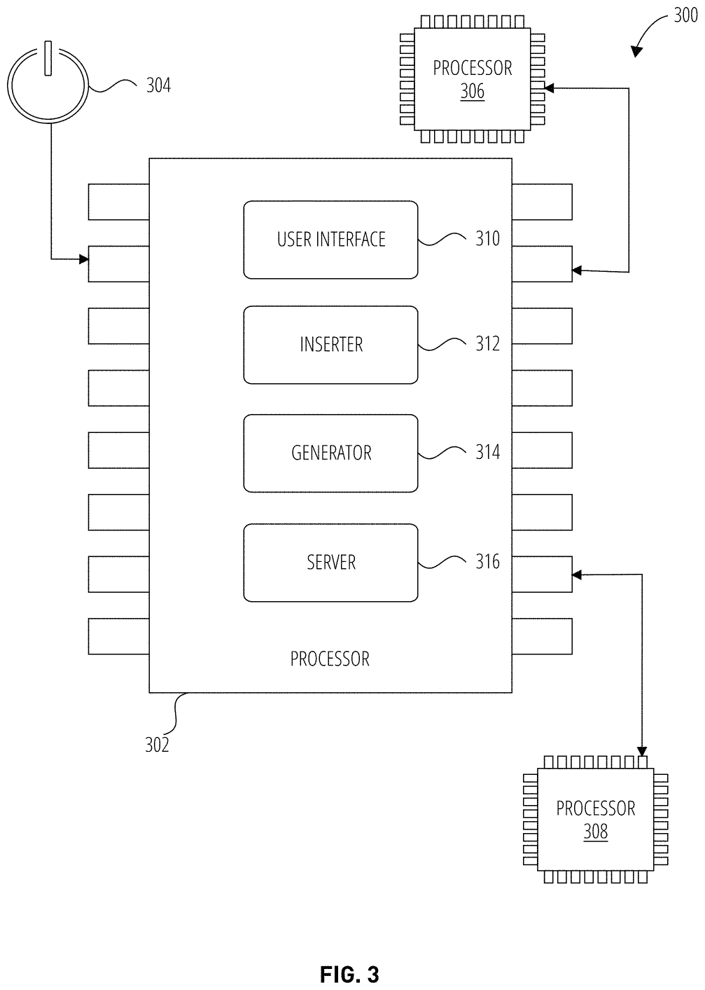

Turning now to FIG. 3, there is shown a diagrammatic representation of a processing environment 300, which includes a processor 302, a processor 306, and a processor 308 (e.g., a GPU, CPU or combination thereof).

The processor 302 is shown to be coupled to a power source 304, and to include (either permanently configured or temporarily instantiated) modules, namely a User interface 310, an inserter 312, and a Generator 314. The User interface 310 operationally generates a user interface that enables the receipt of a seed page and enables receipt of inputs for the received seed page, the inserter 312 operationally inserts variables (e.g., geo-based, product, manufacturer, etc.) into the received seed page, the Generator 314 operationally generates landing pages as a function of such variables (e.g., geography, unique content, etc.), and the server 316, which may be a separate processing environment in an embodiment, serves the generated pages when requested (e.g., via organic search engine rankings). As illustrated, the processor 302 is communicatively coupled to both the processor 306 and the processor 308.

During operation of the processing environment 300, the user interface 310 receives a seed landing page source code. The seed landing page may be designed using content management software (CMS) such as WordPress, HubSpot, Shopify, etc. and be in XML or any text-based file format. The inserter 312 then inserts the inputs for called out variables (e.g., geo-specific) into seed page code. The inserter 312 can do the inserting by identifying variables (e.g., geography such as city of San Jose) defined by the user. The inserter 312 may also insert a variable into image Exif geolocation tags. For example, for a seed page created for San Jose, the text in the XML code for San Jose can be replaced with the variable “Geo City.” Note that there may be multiple variables in one seed page including a first variable for city and a second variable for state. An excerpt of code showing text replaced with variables is shown below.

<guid
isPermalink=“false”>http://bankruptcylegal.org/?page_id=61</guid>
<description/>
+<content:encoded>
-<![CDATA[<div>Bankruptcy Legal</div> <h1><span>Geo City Bankruptcy
Attorneys</span></h1> <h1><span>Geo City Bankruptcy
Attorneys</span></h1>

Alternatively, a user, using the user interface 310, may identify where to insert the variables in the code of the seed landing page.

The generator 314 then generates a plurality of landing pages (e.g., geo-specific) using the code from the seed landing page. To generate a geo-specific landing page, the generator 314 replaces the inserted variables with corresponding geographies, e.g., for Geo City variable San Jose, or replace GPS coordinates in an Exif tag for a photo with San Jose coordinates (37.3382° N, 121.8863° W). A user can specify with the user interface 310 which geographies to generate landing pages for or a default can be specified (e.g., all counties in the U.S. having a population above a prespecified amount or specified by a user, etc.). The generator 314 can also replace variables with other text as a function of unique content (i.e., not only the geography name). The following tables show the data that can inserted to generate two example geo-specific landing pages having their own urls.

| | geo- | Geo | | geo- | | |
|---|---|---|---|---|---|---|
| geourl | city | City | GeoState | exif-gps | GeoZipCode | GeoSeoTitle |
| bankruptcy- | acres- | Acres | CO | 39.55666, | 80124 | Geo City, |
| attorneys- | green- | Green | | −104.89609 | | GeoState |
| acres-green- | co | | | | | Bankruptcy |
| co | | | | | | Lawyers |
| bankruptcy- | aetna- | Aetna | CO | 39.73813, | 80018 | Geo City, |
| attorneys- | estates- | Estates | | −104.67325 | | GeoState |
| aetna- | co | | | | | Bankruptcy |
| estates- | | | | | | Lawyers |
| co | | | | | | |

Other variables not shown can include, for example, GeoSeoMeta, geo-exif-title, geo-exif-keywords, and geo-exif-description. These other variables, such as GeoSeoMeta, may include text and be nested, such as, “Looking for the best Geo City, GeoState bankruptcy lawyer? We've got you covered. Hiring the right law firm should be an easy and positive experience.” geo-exif-title might include “Bankruptcy Lawyers in Geo City, GeoState.” geo-exif-keywords might include “Geo City bankruptcy attorneys, legal specialists, positive experience.” geo-exif-description might include the same text as GeoSeoMeta or can include different text.

Note that two examples are listed in the table above for ease of illustration. There is no limit to the number of landing pages that may be created nor number of variables.

In addition, the generator 314 can insert map coordinates into mapping APIs to display maps appropriate for the specified geography (e.g., a map for San Jose when geo-city equals San Jose).

The server 316, in response to a request to serve a geo-specific landing page from a client device, serves the geo-specific landing page that was generated by the generator 314.

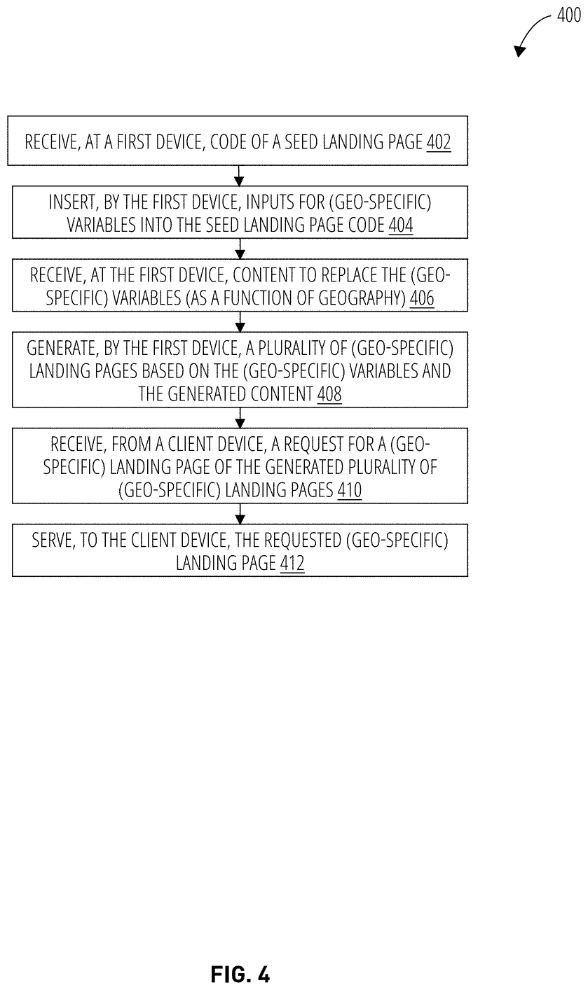

FIG. 4 illustrates a method 400 in accordance with one embodiment. In an example embodiment, the processing environment 300 can execute the method 400 using the user interface 310, the inserter 312, the generator 314 and the server 316. Example methods described herein may also be implemented in the form of executable instructions stored on a machine-readable medium or in the form of electronic circuitry. For instance, the operations of the method 400 may be represented by executable instructions that, when executed by a processor of a computing device, cause the computing device to perform the method 400.

Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel.

In block 402, a first device (e.g, the processing environment 300) receives code of a seed landing page. In block 404, the first device inputs for the variables (e.g., geo-specific, product or manufacturer specific, etc.) into the seed landing page code. In block 406, the first device receives content to replace the variables (e.g., as a function of geography). In block 408, the first device generates a plurality of landing pages (that may be geo-specific) based on the variables and the generated content. In block 410, the first device or other server receives a request for a landing page (that may be geo-specific) of the generated plurality of landing pages. In block 412, the first device or other server serves to the client device the requested landing page.

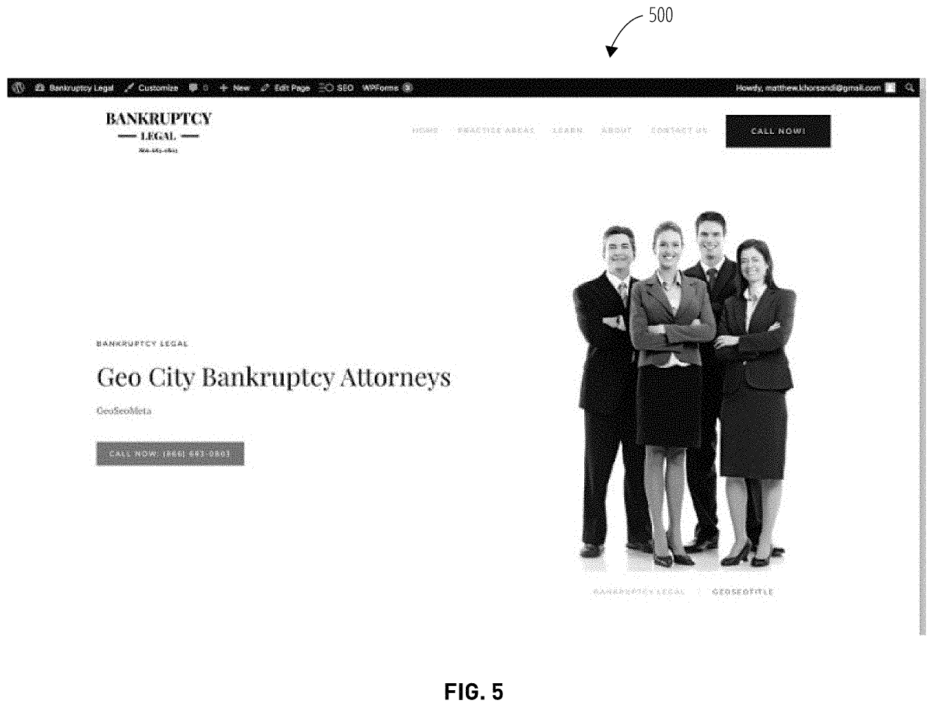

FIG. 5 illustrates an example seed landing page 500. The seed landing page 500 displays variables that can be replaced with geo-specific content to generate landing pages. For example, Geo City, GeoSeoMeta, GeoSeoTitle, etc.

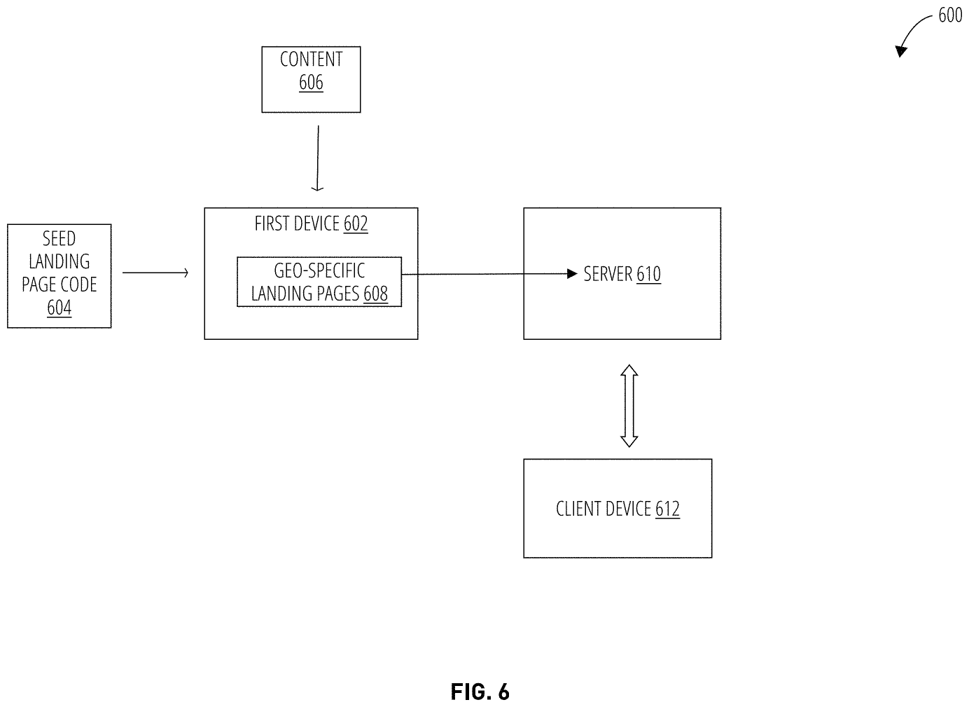

FIG. 6 illustrates a network 600 implementing the method illustrated by FIG. 4. A first device 602 receives seed landing page code 604 and content 606 to generate geo-specific landing pages 608, such as landing pages for Acres Greens and Aetna Estates. The generated geo-specific landing pages 608 can be then be transferred to a server 610, which then serves a requested landing page from the generated geo-specific landing pages 608 to a client device 612.

In view of the disclosure above, various examples are set forth below. It should be noted that one or more features of an example, taken in isolation or combination, should be considered within the disclosure of this application.

1. A method of serving unique web landing pages, comprising:

receiving, at a first device, code of a seed landing page:
inserting, by the first device, a (geo-specific) variable into the seed landing page code;
receiving, at the first device, content to replace the variable as a function of desired content;
generating, by the first device, a plurality of unique (geo-specific) landing pages based on the variables and the content;
receiving, from a client device, a request for one unique (geo-specific) landing page of the generated plurality of landing pages; and
serving, to the client device, the requested (geo-specific) landing page.

2. The method of example 1, wherein the (geo-specific) variable is inserted into exif data of an image in the seed landing page.

3. The method of any of the preceding examples, wherein the inserting inserts a plurality of geo-specific variables into the seed landing page and a second geo-specific variable is nested within a first geo-specific variable.

4. The method of any of the preceding examples, wherein the (geo-specific) variable includes a city.

5. The method of any of the preceding examples, wherein the (geo-specific) variable includes a title of the generated landing page.

6. The method of any of the preceding examples, wherein the (geo-specific) variable includes metadata.

7. The method of any of the preceding examples, wherein the (geo-specific) variable includes map data.

8. The method of any of the preceding examples, further comprising inserting a search engine dependent variable into the seed landing page code and the generating generates the plurality of pages also based on the search engine dependent variable.

9. The method of any of the preceding examples, wherein the (geo-specific) variable includes a URL.

10. A non-transitory computer-readable storage medium, the computer-readable storage medium including instructions that when executed by a computer, cause the computer to:

receive, at the computer, code of a seed landing page;
insert, by the computer, a (geo-specific) variable into the seed landing page code;
receive, at the computer, content to replace the variable as a function of desired content;
generate, by the computer, a plurality of unique (geo-specific) landing pages based on the variables and the content;
receive, from a client device, a request for one unique (geo-specific) landing page of the generated plurality of landing pages; and
serve, to the client device, the requested (geo-specific) landing page.

11. A computing apparatus comprising:

a processor; and
a memory storing instructions that, when executed by the processor, configure the apparatus to:
receive, at the apparatus, code of a seed landing page;
insert, by the apparatus, a (geo-specific) variable into the seed landing page code;
receive, at the apparatus, content to replace the variable as a function of desired content;
generate, by the apparatus, a plurality of unique (geo-specific) landing pages based on the variables and the content;
receive, from a client device, a request for one unique (geo-specific) landing page of the generated plurality of landing pages; and
serve, to the client device, the requested landing page.

12. The computing apparatus of any of the preceding examples, wherein the (geo-specific) variable is inserted into exif data of an image in the seed landing page.

13. The computing apparatus of any of the preceding examples, wherein the inserting inserts a plurality of geo-specific variables into the seed landing page and a second geo-specific variable is nested within a first geo-specific variable.

14. The computing apparatus of any of the preceding examples, wherein the (geo-specific) variable includes a city.

15. The computing apparatus of any of the preceding examples, wherein the (geo-specific) variable includes a title of the generated landing page.

16. The computing apparatus of any of the preceding examples, wherein the (geo-specific) variable includes metadata.

17. The computing apparatus of any of the preceding examples, wherein the (geo-specific) variable includes map data.

18. The computing apparatus of any of the preceding examples, wherein the instructions further configure the apparatus to insert a search engine dependent variable into the seed landing page code and the generating generates the plurality of pages also based on the search engine dependent variable.

19. The computing apparatus of any of the preceding examples, wherein the (geo-specific) variable includes a URL.

### Glossary

“Carrier signal” refers to any intangible medium that is capable of storing, encoding, or carrying instructions for execution by the machine, and includes digital or analog communications signals or other intangible media to facilitate communication of such instructions. Instructions may be transmitted or received over a network using a transmission medium via a network interface device.

“Client device” refers to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors 220 or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Ephemeral message” refers to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“Machine storage medium” refers to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers to a tangible medium that is capable of storing, encoding, or carrying the instructions for execution by a machine.

“Signal medium” refers to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

What is claimed is:

1. A method of serving unique web landing pages, comprising:
receiving, at a first device, code of a seed landing page;
inserting, by the first device, a variable into the seed landing page code;
receiving, at the first device, content to replace the variable as a function of desired content;
generating, by the first device, a plurality of unique landing pages based on the variables and the content;
receiving, from a client device, a request for one unique landing page of the generated plurality of landing pages; and
serving, to the client device, the requested landing page.

2. The method of claim 1, wherein the variable is inserted into exif data of an image in the seed landing page.

3. The method of claim 1, wherein the inserting inserts a plurality of geo-specific variables into the seed landing page and a second geo-specific variable is nested within a first geo-specific variable.

4. The method of claim 1, wherein the variable includes a city.

5. The method of claim 1, wherein the variable includes a title of the generated landing page.

6. The method of claim 1, wherein the variable includes metadata.

7. The method of claim 1, wherein the variable includes map data.

8. The method of claim 1, further comprising inserting a search engine dependent variable into the seed landing page code and the generating generates the plurality of pages also based on the search engine dependent variable.

9. The method of claim 1, wherein the variable includes a URL.

10. A non-transitory computer-readable storage medium, the computer-readable storage medium including instructions that when executed by a computer, cause the computer to:
receive, at the computer, code of a seed landing page;
insert, by the computer, a variable into the seed landing page code;
receive, at the computer, content to replace the variable as a function of desired content;
generate, by the computer, a plurality of unique landing pages based on the variables and the content;
receive, from a client device, a request for one unique landing page of the generated plurality of landing pages; and
serve, to the client device, the requested landing page.

11. A computing apparatus comprising:
a processor; and
a memory storing instructions that, when executed by the processor, configure the apparatus to:
receive, at the apparatus, code of a seed landing page;
insert, by the apparatus, a variable into the seed landing page code;
receive, at the apparatus, content to replace the variable as a function of desired content;
generate, by the apparatus, a plurality of unique landing pages based on the variables and the content;
receive, from a client device, a request for one unique landing page of the generated plurality of landing pages; and
serve, to the client device, the requested landing page.

12. The computing apparatus of claim 11, wherein the variable is inserted into exif data of an image in the seed landing page.

13. The computing apparatus of claim 11, wherein the inserting inserts a plurality of geo-specific variables into the seed landing page and a second geo-specific variable is nested within a first geo-specific variable.

14. The computing apparatus of claim 11, wherein the variable includes a city.

15. The computing apparatus of claim 11, wherein the variable includes a title of the generated landing page.

16. The computing apparatus of claim 11, wherein the variable includes metadata.

17. The computing apparatus of claim 11, wherein the variable includes map data.

18. The computing apparatus of claim 11, wherein the instructions further configure the apparatus to insert a search engine dependent variable into the seed landing page code and the generating generates the plurality of pages also based on the search engine dependent variable.

19. The computing apparatus of claim 11, wherein the variable includes a URL.
